(19) United States
(12) Patent Application Publication
(10) Pub. No.: US 2018/0081084 A1
(43) Pub. Date: Mar. 22, 2018

(54) ANTI-REFLECTIVE COATINGS AND METHODS FOR OPTICAL LENSES

(71) Applicant: Honeywell International Inc., Morris Plains, NJ (US)

(72) Inventors: Shaopeng Zhu, Shanghai (CN); Philip M. Johnson, Charlton, MA (US); Jon F. Nebo, Waltham, MA (US); Wanchao Jiang, Shanghai (CN); Siyuan Zhang, Shanghai (CN); Gang Xu, Shanghai (CN); Linan Zhao, Shanghai (CN)

(21) Appl. No.: 15/708,439

(22) Filed: Sep. 19, 2017

Related U.S. Application Data
(60) Provisional application No. 62/397,704, filed on Sep. 21, 2016.

(51) Int. Cl. G02B 1/111; G02C 7/10; B05D 5/06

(52) U.S. Cl. CPC G02B 1/111; B05D 1/18; B05D 5/06; G02C 7/104

(57) ABSTRACT

Anti-reflective (AR) coatings and methods for applying AR coatings to substrates, such as optical lenses. The coating may include a polyurethane base layer and a fluoropolymer top layer. The base layer may protect the underlying substrate, promote adhesion between the top layer and the underlying substrate, and achieve index-matching with the underlying substrate. The method may involve an inexpensive and efficient solution coating process.

### CROSS REFERENCE TO RELATED APPLICATIONS

This application claims the benefit under Title 35, U.S.C. §119(e) of U.S. Provisional Patent Application Ser. No. 62/397,704, entitled ANTI-REFLECTIVE COATINGS AND METHODS FOR OPTICAL LENSES, filed on Sep. 21, 2016, the entire disclosure of which is expressly incorporated by reference herein.

### FIELD

The present disclosure relates to anti-reflective (AR) coatings and methods for applying AR coatings. In particular, the present disclosure relates to AR coatings and methods for applying AR coatings to optical lenses, such as optical lenses used in safety eyewear, other eyewear, and cameras, for example. The AR coatings may also have other uses, such as on exhibition windows, car windows, aircraft windows, train and other mass transit windows, and glove boxes, for example.

### BACKGROUND

AR coatings are applied to optically transparent substrates to decrease the amount of incident light that is reflected from the substrate (i.e., the reflection fraction) and increase the amount of light that is transmitted through the substrate (i.e., the transmission fraction). In the context of eyewear lenses, such AR coatings allow more light to pass through the lenses and into the wearer's eyes, which may alleviate distracting and potentially harmful double images and glare.

Current AR coating techniques involve expensive and time-consuming processes, such as physical vapor deposition (PVD) processes. Therefore, current AR coatings are not available for less expensive eyewear, such as plano safety eyewear, and instead are reserved for expensive eyewear, such as prescription safety eyewear.

### SUMMARY

The present disclosure relates to AR coatings and methods for applying AR coatings to substrates, such as optical lenses. The coating may include a polymer base layer and a fluoropolymer top layer. The base layer may protect the underlying substrate, promote adhesion between the top layer and the underlying substrate, and achieve index-matching with the underlying substrate. The method may involve inexpensive and efficient solution coating processes.

In one form thereof, the present disclosure provides an anti-reflective product including an optically transparent substrate having a first side and a second side, a polymer base layer on at least one of the first and second sides of the substrate, and an anti-reflective fluoropolymer top layer on the base layer, wherein the product reflects 3% or less of incident light at wavelengths from 380 nm to 780 nm.

In another form thereof, the present disclosure provides an anti-reflective product including an optically transparent substrate having a first side and a second side, a first polymer base layer on the first side of the substrate, a second polymer base layer on the second side of the substrate, a first anti-reflective fluoropolymer top layer on the first base layer, and a second anti-reflective fluoropolymer top layer on the second base layer.

In a further form thereof, the present disclosure provides a method of manufacturing an anti-reflective product including applying a first solution comprising a resin to at least one side of an optically transparent substrate, curing the resin to form a smooth base layer on the substrate, applying a second solution comprising a fluoropolymer onto the smooth base layer, and solidifying the fluoropolymer to form an anti-reflective top layer on the smooth base layer.

### BRIEF DESCRIPTION OF THE DRAWINGS

The above mentioned and other features of the invention, and the manner of attaining them, will become more apparent and the invention itself will be better understood by reference to the following description of embodiments of the invention taken in conjunction with the accompanying drawings.

FIG. 1 is a schematic view of a first exemplary AR product including a substrate and an AR coating on one side of the substrate;

FIG. 2 is a schematic view of a second exemplary AR product including a substrate and an AR coating on both sides of the substrate;

FIG. 3 is a perspective view of an exemplary pair of safety eyewear including the AR product of the present disclosure;

FIG. 4 is a flow diagram of a method for manufacturing the AR products of FIGS. 1 and 2;

FIG. 5 is a graph presenting reflectance data of Example 1; and

FIG. 6 is a series of photographs presenting double image data of Example 1.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

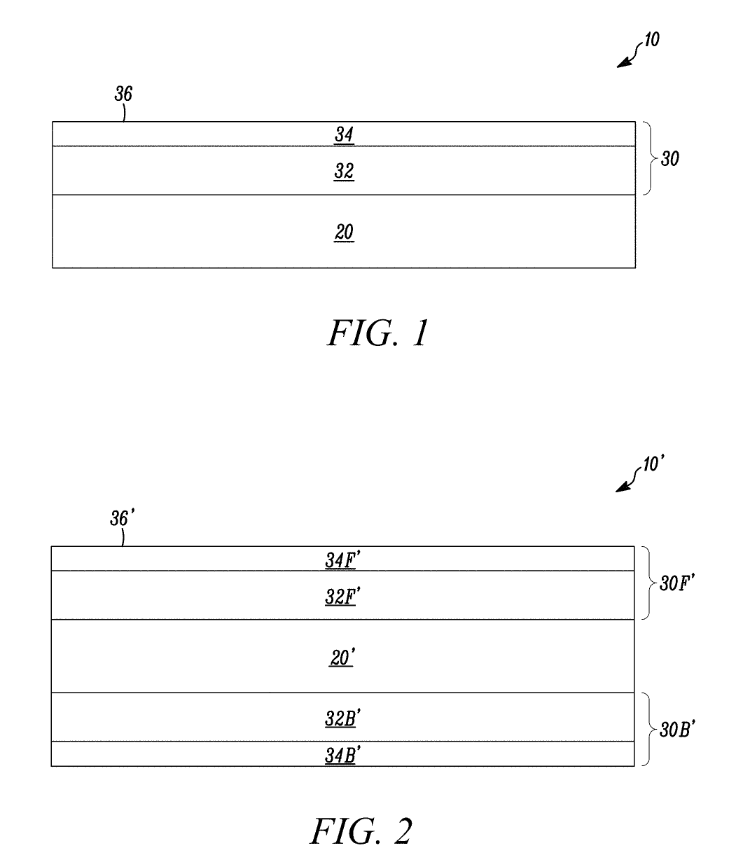

Referring initially to FIG. 1, an exemplary AR product 10 is disclosed having a substrate 20 and at least one AR coating 30. The illustrative coating 30 includes a base layer 32 in contact with substrate 20 and a top layer 34 in contact with base layer 32. Top layer 34 of coating 30 defines an outer surface 36 of product 10 that is exposed to incident light. In this embodiment, the coated front side of substrate 20 may serve an optical function, whereas the uncoated back side of substrate 20 may not.

Another exemplary AR product 10′ is shown in FIG. 2. Product 10′ of FIG. 2 is similar to product 10 of FIG. 1 with like reference numerals indicating like elements, except both sides of substrate 20′ are coated. More specifically, the front side of substrate 20′ includes a front side coating 30F′ with a corresponding base layer 32F′ and top layer 34F′, and the back side of substrate 20′ includes a back side coating 30B′ with a corresponding base layer 32B′ and top layer 34B′. In this embodiment, both the coated front side and the coated back side of substrate 20′ may serve optical functions.

The following description references product 10 of FIG. 1, but this description is also applicable to product 10′ of FIG. 2.

Substrate 20 of product 10 is an optically transparent lens or another suitable substrate. Substrate 20 may be constructed of plastic, such as polycarbonate (PC), allyl diglycol carbonate (ADC) (also referred to as CR-39), poly(methyl methacrylate) (PMMA), or another suitable material.

The refractive index of substrate 20 (n_substrate) may be as low as about 1.30, 1.35, 1.40, 1.45, or 1.50 and as high as about 1.55, 1.60, 1.65, or 1.70, or within any range defined between any pair of the foregoing values. For example, the refractive index of substrate 20 may be from about 1.45 to about 1.65. In one embodiment, substrate 20 is a PC safety eyewear lens having a refractive index of 1.59.

Base layer 32 of product 10 may be a relatively high-index film (i.e., a film having a relatively high refractive index) that is applied to substrate 20 as an intermediate layer between substrate 20 and top layer 34. Base layer 32 may be constructed of a cross-linked polyurethane, which may be formed by reacting (1) at least one isocyanate and (2) at least one polyol. Suitable isocyanates for use as ingredient (1) include aliphatic diisocyanates, aromatic diisocyanates, polyisocyanates, or combinations thereof. Suitable polyols for use as ingredient (2) have two or more hydroxyl groups and include aliphatic polyols, aromatic polyols, polymeric polyols (e.g., polyether, polyester polyols), or combinations thereof. The polyurethane resin may soluble in organic solvents, which allows the polyurethane resin to be provided as a liquid solution. An exemplary material for base layer 32 is a FormGard™ coating available from FSI Coating Technologies. In other embodiments, base layer 32 may be constructed of an epoxy, polyester, melamine resin cross linked polyester coating, other melamine resin cross linked polymer coatings such as alkyl-esterified melamine-formaldehyde resins which may be combined with and cross link resins such as acrylic, alkyd, epoxy, polyether, polyesters, as well as acrylate polymers, or other polymeric or hybrid coatings that are compatible with the substrate and within the desired refractive index range.

The thickness of base layer 32 may be as low as about 0.5, 1, 2, 3, 4, 5, 6, 7, 8, or 9 μm and as high as about 10, 11, 12, 13, 14, 15, 16, 17, 18, 19, or 20 μm, or within any range defined between any pair of the foregoing values. For example, the thickness of base layer 32 may be from about 2 μm to about 7 μm, more specifically about 5 μm.

The refractive index of base layer 32 may vary depending on the refractive index of substrate 20. The refractive index of base layer 32 may be controlled by altering the amount of aromatic functional groups, high-index functional groups (e.g., sulfur), or other high-index additives in base layer 32, for example. According to an exemplary embodiment of the present disclosure, the refractive index of base layer 32 (n_base) is calculated based on the refractive index of substrate 20 (n_substrate) according to the following formula:

n_substrate−0.01<n_base<n_substrate+0.1

In the example wherein substrate 20 is a PC lens having a refractive index of 1.59, the refractive index of base layer 32 may be from 1.58 (calculated as 1.59−0.01) to 1.69 (calculated as 1.59+0.1). A suitable base layer 32 for use in this example is the FormGard™ coating available from FSI Coating Technologies, which has a refractive index of 1.58 to 1.59.

Top layer 34 of product 10 may be a low-index fluoropolymer film (i.e., a film having a relatively low refractive index) that is applied to bottom layer 32. Top layer 34 may be constructed of an amorphous copolymer formed from: (1) at least one fluorinated alkene and (2) at least one fluorine-containing compound having a carbon-carbon double bond. Suitable fluorinated alkenes for use as ingredient (1) include vinylidene fluoride (VDF), tetrafluoroethylene (TFE), trifluoroethylene, hexafluoropropylenes, pentafluoropropenes, trifluoropropenes (e.g., trans-1-chloro-3,3,3-trifluoropropene (HFO-1233zd)), tetrafluoropropenes (e.g., 1,3,3,3-tetrafluoropropene (HFO-1234ze), 2,3,3,3-tetrafluoropropene (HFO-1234yf)), heterocyclic fluoropolymers (e.g., poly(1,1,2,4,4,5,5,6,7,7-decafluoro-3-oxa-1,6-heptadiene), which is available as CYTOP from Asahi Glass Co., Ltd.), and combinations thereof. Suitable fluorine-containing compounds for use as ingredient (2) include the fluorinated alkenes of ingredient (1), fluorinated acrylates and acrylate esters (e.g., dihydroperfluorobutyl methacrylate, dihydroperfluorooctyl methacrylate), fluorinated ethers, fluorinated heterocyclic compounds (e.g., 2,2-bis(trifluoromethyl)-4,5-difluoro-1,3-dioxole (PDD)), and combinations thereof. The molar ratio of ingredients (1):(2) may vary from about 2:1 to about 1:4, more specifically about 1:1 to 1:3, more specifically about 1:2.

The fluoropolymer may be soluble in organic solvents (e.g., propylene glycol methyl ether (PGME)), which allows the fluoropolymer to be provided as a clear liquid solution. The concentration of the fluoropolymer concentration in the solution may be as low as about 0.5, 1, or 2 wt. % and as high as about 3, 4, or 5 wt. %, or within any range defined between any pair of the foregoing values.

An exemplary material for top layer 34 is a copolymer of VDF as ingredient (1) and HFO-1234ze as ingredient (2), with a weight average molecular weight (Mw) of about 10⁶ and a molar ratio of VDF:HFO-1234ze of about 1:2. The VDF and HFO-1234ze copolymer may be dissolved in PGME at a concentration of about 1 wt. % to produce a clear liquid solution.

The thickness of top layer 34 may be less than the thickness of base layer 32. In certain embodiments, the thickness of top layer 34 may be as low as about 50, 55, 60, 65, 70, 75, 80, 85, or 90 nm and as high as about 95, 100, 105, 110, 115, 120, 125, 130, 135, 140, 145, or 150 nm, or within any range defined between any pair of the foregoing values. For example, the thickness of top layer 34 may be from about 90 nm to about 120 nm, more specifically about 105 nm. The thickness of top layer 34 can be controlled, as necessary, by adjusting the fluoropolymer concentration of the solution.

The refractive index of top layer 34 may be less than both the refractive index of substrate 20 and the refractive index of base layer 32. In certain embodiments, the refractive index of top layer 34 may be as low as about 1.10, 1.15, 1.20, 1.25, or 1.30 and as high as about 1.35, 1.40, 1.45, or 1.50, or within any range defined between any pair of the foregoing values. For example, the refractive index of top layer 34 may be from about 1.35 to about 1.45, more specifically about 1.38.

To accommodate light at a targeted wavelength (λ), the thickness of top layer 34 (thickness_top) may be calculated based on the refractive index of top layer 34 (n_top), according to the following formula:

thickness_top=λ/n_top/4

If the targeted wavelength is 580 nm (which is the midpoint of 380 nm to 780 nm) and top layer 34 has a refractive index of 1.38, for example, the thickness of top layer 34 may be 105 nm (calculated as 580 nm/1.38/4).

Base layer 32 and top layer 34 of coating 30 may be substantially smooth and solid (i.e., non-porous) layers that lack intentional irregularities. Due to the smooth and solid nature of coating 30, the coated product 10 may have a haze value as low as about 0.05%, 0.10%, 0.15%, 0.20%, 0.25%, 0.30%, 0.35%, 0.40%, 0.45%, or 0.50% and as high as about 0.60%, 0.65%, 0.70%, 0.75%, 0.80%, 0.85%, 0.90%, 0.95%, or 1.00%, or within any range defined between any pair of the foregoing values. For example, the coated product 10 may have a haze value from about 0.05% to about 0.50%, more specifically from about 0.15% to about 0.25%. The haze value may be measured in accordance with ASTM D1003.

The coated product 10 may be scratch resistant. This scratch resistance may be measured using a Bayer test in accordance with ASTM F735, for example. In certain embodiments, the Bayer ratio may be greater than 1, 1.5, 2, 2.5, 3, or more.

The coated product 10 may also be inherently hydrophobic and water resistant. As a result, the coated product 10 may prevent the formation of water spots and facilitate cleaning.

The coated product 10 may also have strong adhesion between coating 30 and the underlying substrate 20. This adhesion may be measured using a cross-hatch test, for example. In certain embodiments, the adhesion may be rated as high as ASTM Class 5B in accordance with the cross-hatch test of ASTM D3359.

The coated product 10 may also be durable enough to withstand harsh environmental conditions, such as prolonged exposure to boiling water, salt water, damp heat, organic solvents, acidic solutions, and/or basic solutions, with little or no visible deterioration. This environmental durability may be tested in accordance with ISO 9211, for example. In certain embodiments, the coated product 10 may maintain strong adhesion between coating 30 and the underlying substrate 20 even after exposure to these environmental conditions.

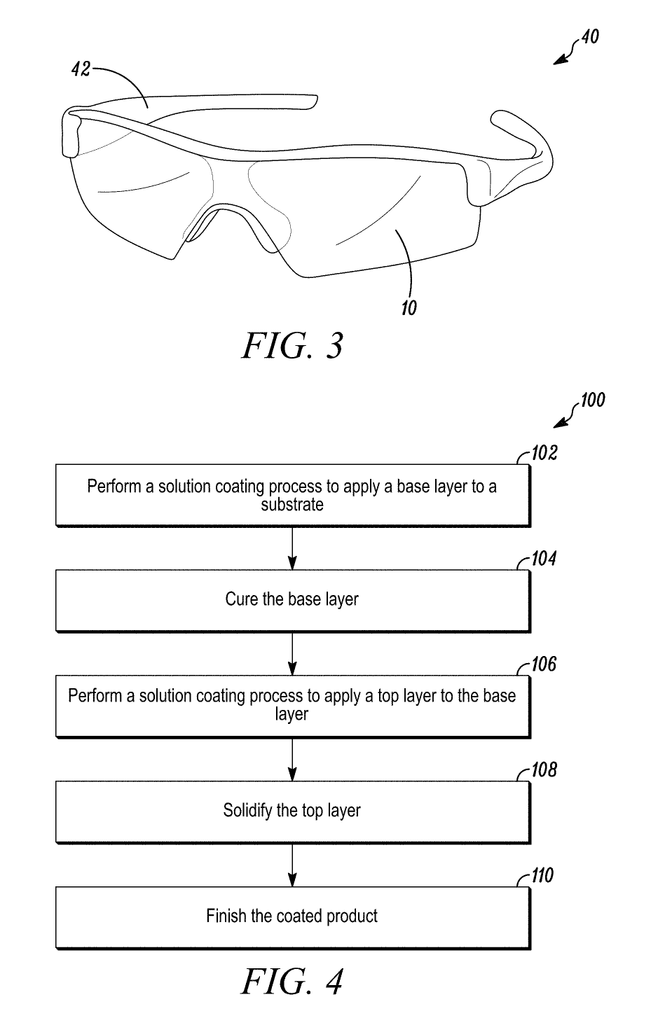

According to an exemplary embodiment of the present disclosure, the coated product 10 may be used as a lens in plano safety eyewear 40 having a frame 42, as shown in FIG. 3. In other embodiments, the coated product 10 may be used in prescription safety eyewear, other eyewear, or cameras, for example. The coated product 10 may also have other uses, such as on exhibition windows, car windows, aircraft windows, train and other mass transit windows, and glove boxes, for example.

Referring next to FIG. 4, an exemplary method 100 is disclosed for manufacturing the coated product 10 of FIG. 1, but this description is also applicable to the coated product 10′ of FIG. 2.

In step 102, base layer 32 is applied to substrate 20. If the polyurethane resin of base layer 32 is present as a solution, step 102 may involve a solution coating process, such as dip-coating, flow-coating, spin-coating, or spray-coating the solution onto substrate 20. In one particular example, step 102 involves dip-coating the substrate 20 in the solution of base layer 32 one or more times.

In step 104, base layer 32 is cured upon substrate 20, which may involve thermal, moisture, and/or UV treatments to evaporate or otherwise remove excess solvents and form adequate cross-links in the polyurethane base layer 32. The temperature and time of the curing step 104 may be selected to adequately cure base layer 32 while maintaining the structural integrity of the underlying substrate 20. If substrate 20 is constructed of PC, for example, the curing step 104 may be performed at a temperature less than the glass transition temperature (Tg) of the PC substrate 20, such as less than about 130 degrees C. In one particular example, the curing step 104 is performed at about 125 degrees C. for about 1 hour.

In step 106, top layer 34 is applied to the cured base layer 32. If the fluoropolymer of top layer 34 is present as a solution, step 106 may involve a solution coating process, such as dip-coating, flow-coating, spin-coating, or spray-coating the solution onto base layer 32. In one particular example, step 106 involves dip-coating the substrate 20 and base layer 32 in the solution of top layer 34 one or more times.

In step 108, top layer 34 is solidified upon base layer 32 and substrate 20, which may involve thermal, moisture, and/or UV treatments to evaporate or otherwise remove excess solvents from top layer 34. In certain embodiments, the solidifying step 108 may also involve forming cross-links in the fluoropolymer top layer 34. The temperature and time of the solidifying step 108 may be selected to adequately dry and solidify top layer 34 while maintaining the structural integrity of the underlying base layer 32 and substrate 20. For example, the solidifying step 108 may be performed at a temperature as low as about 70, 80, or 90 degrees C. and as high as about 100, 110, or 120 degrees C., or within any range defined between any pair of the foregoing values, for about 5, 10, 15 minutes, or more. In one particular example, the solidifying step 108 involves thermally treating top layer 34 at about 80 degrees C. for about 15 minutes.

Finally, in step 110, the coated product 10 is subjected to any necessary finishing steps. In one particular example, the finishing step 110 involves incorporating the coated product 10 into safety eyewear 40, as shown in FIG. 3.

Product 10 and method 100 offer several advantages, as described below. First, the cross-linked nature of base layer 32 may protect the underlying substrate 20, both during and after assembly. During assembly, base layer 32 may protect substrate 20 from potential corrosion caused by the solvents used to form top layer 34. After assembly, base layer 32 may provide a solid base that continues protecting substrate 20 from scratches and other damage. Second, the relatively high-index of base layer 32 may promote index-matching to enhance the AR properties of product 10. Third, base layer 32 may promote good adhesion between the low-surface-energy fluoropolymer of top layer 34 and the underlying substrate 20. Fourth, the solution coating processed described in method 100 may be significantly faster, cheaper, and simpler than traditional PVD processes, without the need for high vacuum, high temperature, frequent maintenance, precise process control, and clean rooms, for example. As a result, method 100 may be expanded beyond just expensive products, such as prescription safety eyewear, and used to produce less expensive products, such as plano safety eyewear.

The above advantages may be achieved without sacrificing optical performance. In fact, optical performance may be improved compared to known products, because coating 30 may be considered a broadband AR coating that achieves light reflectance of 3% or less over the entire visible light spectrum. In certain embodiments, the visible light spectrum may be relatively broad and include wavelengths from 380 nm to 780 nm, pursuant to ANSI Z87 standards. In other embodiments, the visible light spectrum may be relatively narrow and include wavelengths from 400 nm to 700 nm or 400 nm to 750 nm, pursuant to ISO 9211 standards and Chinese JB/QB standards. Also, coating 30 may reduce the appearance of double images compared to known products.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### EXAMPLE

Test samples were produced by forming an AR coating on both sides of left and right PC safety eyewear lenses. First, each lens was dip-coated in a FormGard™ polyurethane resin, which was then cured at about 125 degrees C. for about 1 hour to produce a base layer having a thickness of 5 μm and a refractive index of 1.59. Next, each coated lens was dip-coated in a 1 wt. % VDF and HFO-1234ze copolymer (Mw=10⁶; VDF:HFO-1234ze=1:2)/PGME solution and thermally treated at about 80 degrees C. for about 15 minutes to form a top layer having a thickness of about 90 nm and a refractive index of 1.38.

The test samples described above were compared to other samples, as summarized in Table I below.

TABLE I
Description of Comparative Samples

| | |
|---|---|
| Sample | Description |
| Control Sample | uncoated PC lenses |
| Comparative | Supersonic ™ lenses from Protective Industrial |
| Sample A | Products, Inc. |
| Comparative | UVEX i-3 lenses from Uvex Safety Group GmbH |
| Sample B | & Co. KG |
| Comparative | RUSH lenses from Bollé Safety |
| Sample C | |

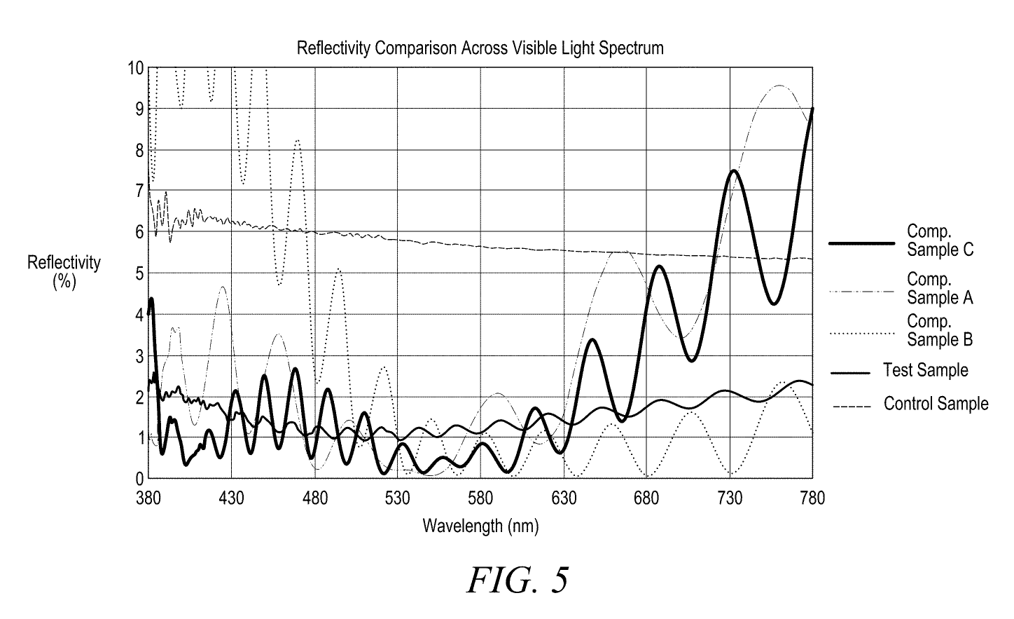

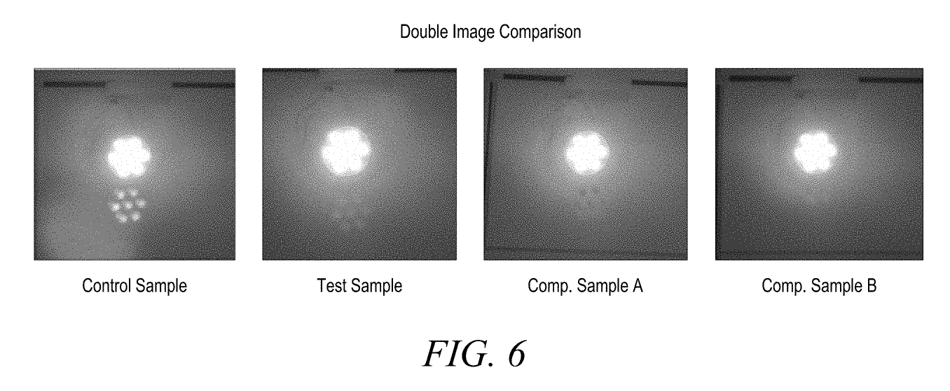

The optical performance and other properties of each coated lens were tested. The results are presented in Table II below and in FIGS. 5 and 6.

TABLE II
Comparison of Key Parameters

| | | Control | Comparative | Comparative | Comparative | Test |
|---|---|---|---|---|---|---|
| Parameter | Spec. | Sample | Sample A | Sample B | Sample C | Sample |
| Visible Light | ≥95.5% | 85.9% | 96.2% | 95.9% | 96.2% | 97.2% |
| Transmittance | (ASNI Z87; | | | | | |
| (VLT) | ASTM D1003) | | | | | |
| Reflectance | ≤3.0% | 5.80% | 3.18% | 3.27% | 2.32% | 1.55% |
| (380-780 nm) | | | | | | |
| Haze | ≤3.0% | 0.05% | 0.08% | 0.16% | 0.06% | 0.18% |
| | (ASNI Z87; | | | | | |
| | ASTM D1003) | | | | | |
| Bayer Ratio | >1 | <0.5 | >3 | >3 | >3 | 2.19 |
| (with hardcoat) | (ASTM F735) | | | | | |
| Adhesion | 5B | N/A | 5B | 5B | 5B | 5B |
| | (ASTM D3359; | | | | | |
| | ISO 9211) | | | | | |
| Number of | N/A | N/A | ≥5 AR + | ≥5 AR + | ≥5 AR + | 1 AR + |
| Coating Layers | | | 1 hardcoat | 1 hardcoat | 1 hardcoat | 1 hardcoat |
| Boiling Water | 05 | N/A | ≥05 | ≥05 | ≥05 | 06 |
| Solubility | (ISO 9211) | | | | | |
| 24-hour | No obvious | N/A | No obvious | No obvious | No obvious | No obvious |
| Saltwater Soak | change | | change | change | change | change |
| Damp Heat Test | C | N/A | D | D | D | C |
| | (ISO 9211) | | | | | |
| Solvent | N/A | Completely | Completely | Completely | Completely | No change |
| Resistance | | damaged by | damaged by | damaged by | damaged by | for 2- |
| | | acetone, | acetone and | acetone and | acetone and | propanol, |
| | | ethyl | ethyl acetate | ethyl acetate | ethyl | hexane, |
| | | acetate, and | | | acetate | toluene, |
| | | toluene | | | | strong acid |
| | | | | | | and base; |
| | | | | | | AR washed |
| | | | | | | by acetone |
| | | | | | | and ethyl |
| | | | | | | acetate |
| Surface | N/A | Hydrophobic | Hydrophobic | Hydrophobic | Hydrophobic | Inherently |
| Hydrophobicity | | (C.A. ~82°) | top-layer | top-layer | top-layer | hydrophobic |
| | | | coated | coated | coated | (C.A. ≥90°) |

As shown in FIG. 5, the comparative samples A and C achieved less reflectance than the control samples at lower wavelengths, and the comparative samples B achieved less reflectance than the control samples at higher wavelengths. The test samples achieved less reflectance than the control samples across all wavelengths. In fact, the test samples achieved broadband AR protection of 3% reflectance or less over the entire visible light spectrum, in this case 380-780 nm.

As shown in FIG. 6, the test samples also decreased the appearance of double images relative to the control and the comparative samples A and B, which indicates that the test samples lack strong reflections at certain wavelengths.

1. An anti-reflective product comprising:
an optically transparent substrate having a first side and a second side;
a polymer base layer on at least one of the first and second sides of the substrate; and
an anti-reflective fluoropolymer top layer on the base layer;
wherein the product reflects 3% or less of incident light at wavelengths from 380 nm to 780 nm.

2. The anti-reflective product of claim 1, wherein the substrate is an eyewear lens.

3. The anti-reflective product of claim 1, wherein the product has a haze value of about 1.00% or less.

4. The anti-reflective product of claim 3, wherein the haze value is from about 0.15% to about 0.25%.

5. The anti-reflective product of claim 1, wherein the base layer is a cross-linked melamine and has a thickness of about 20 μm or less.

6. The anti-reflective product of claim 5, wherein the thickness of the base layer is from about 2 μm to about 7 μm.

7. The anti-reflective product of claim 1, wherein the top layer has a thickness of about 150 nm or less.

8. The anti-reflective product of claim 7, wherein the thickness of the top layer is from about 90 nm to about 120 nm.

9. The anti-reflective product of claim 1, wherein the top layer comprises a copolymer formed from at least one fluorinated alkene and at least one fluorine-containing compound having a carbon-carbon double bond.

10. The anti-reflective product of claim 9, wherein the copolymer of the top layer is formed from vinylidene fluoride and tetrafluoropropene.

11. The anti-reflective product of claim 1, wherein:
the substrate has a refractive index, n_substrate;
the base layer has a refractive index, n_base, calculated according to the following formula:
n_substrate−0.01<n_base<n_substrate+0.1;
and the top layer has a refractive index less than n_substrate and n_base.

12. The anti-reflective product of claim 11, wherein:
the refractive index of the substrate is from about 1.45 to about 1.65; and
the refractive index of the top layer is from about 1.35 to about 1.45.

13. An anti-reflective product comprising:
an optically transparent substrate having a first side and a second side;
a first polymer base layer on the first side of the substrate;
a second polymer base layer on the second side of the substrate;
a first anti-reflective fluoropolymer top layer on the first base layer; and
a second anti-reflective fluoropolymer top layer on the second base layer.

14. The anti-reflective product of claim 13, wherein the substrate is an eyewear lens, the first side of the substrate facing forward away from a wearer's eye and the second side of the substrate facing rearward toward the wearer's eye.

15. The anti-reflective product of claim 13, wherein:
each of the first and second base layers has a thickness from about 2 μm to about 7 μm; and
each of the first and second top layers has a thickness from about 90 nm to about 120 nm.

16. A method of manufacturing an anti-reflective product comprising:
applying a first solution comprising a resin to at least one side of an optically transparent substrate;
curing the resin to form a smooth base layer on the substrate;
applying a second solution comprising a fluoropolymer onto the smooth base layer; and
solidifying the fluoropolymer to form an anti-reflective top layer on the smooth base layer.

17. The method of claim 16, wherein:
applying the first solution comprises dipping the substrate into the first solution; and
applying the second solution comprises dipping the substrate with the base layer into the second solution.

18. The method of claim 16, wherein the curing step is performed at a temperature of about 130 degrees C. or less.

19. The method of claim 16, wherein the solidifying step is performed at a temperature from about 70 degrees C. to about 120 degrees C.

20. The method of claim 16, wherein the concentration of the fluoropolymer in the second solution is from about 0.5 wt. % to about 5 wt. %.
